(19) United States
(12) Patent Application Publication
(10) Pub. No.: US 2018/0029926 A1
(43) Pub. Date: Feb. 1, 2018

(54) GLASS COMPOSITION FOR SEALING

(71) Applicant: Nihon Yamamura Glass Co., Ltd., Hyogo (JP)

(72) Inventors: Tatsuya SATO, Hyogo (JP); Kozo MAEDA, Hyogo (JP); Yoshitaka MAYUMI, Hyogo (JP)

(73) Assignee: Nihon Yamamura Glass Co., Ltd., Hyogo (JP)

(21) Appl. No.: 15/549,817

(22) PCT Filed: Feb. 8, 2016
(86) PCT No.: PCT/JP2016/053614

§ 371 Date: Oct. 3, 2017

(30) Foreign Application Priority Data
Feb. 9, 2015 (JP) 2015-023628

(51) Int. Cl. C03C 8/24; H01M 8/12; H01M 8/0282; C03C 8/02; C03C 3/064

(52) U.S. Cl. CPC C03C 8/24; C03C 8/02; C03C 3/064; H01M 8/0282; H01M 8/12; C03C 2205/00; H01M 2008/1293

(57) ABSTRACT

Disclosed is a glass composition that gives a high thermal expansion crystallized glass having a thermal expansion coefficient of not less than 130×10⁻⁷/° C. after its firing in the form of powder at a temperature not lower than 850° C. The glass composition is substantially free of alkali metal oxides, and contains 12-25 mass % SiO₂, 10-20 mass % B₂O₃ (but, not including 20 mass %), 18-30 mass % CaO, 15-30 mass % MgO, and 10.5-27 mass % BaO, wherein the glass composition, when fired in the form of glass powder at a temperature of 850-1050° C., forms a crystallized glass that exhibits a thermal expansion coefficient of at least 130×10⁻⁷/° C. in the range of 50-800° C.

### TECHNICAL FIELD

The present invention relates to a glass composition for use in providing a seal between a metal and a metal, a metal and a ceramic, or a ceramic and ceramic, and more specifically to a sealing glass composition for use as a sealant in providing a seal at junctions between each of solid oxide fuel cells (SOFC) and a metal to which it is fixed, or between metal members.

### BACKGROUND ART

Crystallized glass is proposed as a sealant for solid oxide fuel cells. As it is aimed to provide a seal between materials with high thermal expansion, such as metals and ceramics, crystallized glass to be used for that purpose must have a high thermal expansion coefficient comparable to them. If, however, a crystallized glass contains a large amount of alkali metals, they adversely affect the durability of its electrical insulating property and sealing property during its long-time use, leading to easy failure of insulation and sealing properties. Thus, creation of a crystallized glass has been needed that has high thermal expansion without substantial inclusion of alkali metals.

A SiO₂—B₂O₃—CaO—MgO-based glass for use as a sealant for solid oxide fuel cells is proposed that gives a crystallized glass with high thermal expansion after its application to the surface of an article and firing (Patent Documents 1 and 2). The crystallized glass produced by firing those glass in the form of a powder achieves a level of thermal expansion coefficient around 100 to 120×10⁻⁷/° C. (50-800° C.) at most, and has a problem of easy formation of cracks when used for sealing high thermal expansion materials having a greater thermal expansion coefficient that it. Also provided is a powder of SiO₂—B₂O₃—MgO—Al₂O₃-based glass with a low CaO content, with which, however, it is hard to produces a crystallized glass having a 125×10⁻⁷/° C. or greater thermal expansion coefficient after firing.

### PRIOR ART DOCUMENTS

### Patent Documents

### [Patent Document 1] JP2007-161569

### [Patent Document 2] JP2009-46371

### [Patent Document 3] JP2013-203627

### SUMMARY OF INVENTION

### Technical Problem

Against the above background, it is an objective of the present invention to provide a glass composition that consistently produces a high thermal expansion crystallized glass having a thermal expansion coefficient of not less than 130×10⁻⁷/° C. after its firing in the form of powder at a temperature not lower than 850° C.

### Solution to Problem

The present inventors focused on BaO as a material that could produce a BaO—MgO—SiO₂-based or BaO—SiO₂-based high thermal expansion crystals, in the process of investigation to address the problem that the glass described in Patent Documents 1 and 2 cannot attain a high thermal expansion coefficient after firing a powder of such glass, and also focused, regarding the problem that firing of the glass powder described in Patent Document 3 cannot give a crystallized glass having a high thermal expansion coefficient after fired in the form of powder, on a possibility of CaO insufficiency in the glass.

Thus, as a result of intense studies, the present inventors found that if the content of its ingredients falls within respective specific ranges, a SiO₂—B₂O₃—CaO—MgO—BaO-based glass composition consistently gives a high-strength crystallized glass having a thermal expansion coefficient of not less than 130×10⁻⁷/° C. (50-800° C.), which is compatible with metals and ceramics, after firing of its powder at 850-1050° C. The present invention was completed through further studies based on this finding.

Thus, the present invention provides what follows.

1. A sealing glass composition substantially not containing alkali metal oxides, but containing

SiO₂ 12-25 mass %,
B₂O₃ 10-20 mass % (but, not including 20 mass %),
CaO 18-30 mass %,
MgO 15-30 mass %,
BaO 10.5-27 mass %,

wherein the glass composition, when fired in the form of glass powder at a temperature of 850-1050° C., produces a crystallized glass that exhibits a thermal expansion coefficient of at least 130×10⁻⁷/° C. in the range of 50-800° C.

2. The sealing glass composition according to 1 above substantially not containing alkali metal oxides, but containing

SiO₂ 12-20 mass %,
B₂O₃ 13-19 mass %,
CaO 20-29 mass %,
MgO 18-25 mass %,
BaO 10.5-25 mass %,

wherein the glass composition, when fired in the form of glass powder at a temperature of 850-1050° C., produces a crystallized glass that exhibits a thermal expansion coefficient of at least 130×10⁻⁷/° C. in the range of 50-800° C.

3. The sealing glass composition according to 1 or 2 above substantially not containing alkali metal oxides, but containing

SiO₂ 13-18 mass %,
B₂O₃ 13-19 mass %,
CaO 20-29 mass %,
MgO 18-25 mass %,
BaO 13-23 mass %,

wherein the glass composition, when fired in the form of glass powder at a temperature of 850-1050° C., produces a crystallized glass that exhibits a thermal expansion coefficient of at least 130×10⁻⁷/° C. in the range of 50-800° C.

4. The sealing glass composition according to one of 1-3 above, containing one or more species selected from the group consisting of La₂O₃, CeO₂, Yb₂O₃ and Y₂O₃, in a total amount of not more than 3 mass %.

5. The sealing glass composition according to one of 1-4 above in the form of powder.

6. The sealing glass composition according to 5 above, wherein the mean particle size of the powder is 2-25 μm.

7. The sealing glass composition according to 5 or 6 above containing a ceramic filler.

8. The sealing glass composition according to one of 5-7 above containing a solvent and an organic binder, and in the form of paste.

9. Solid oxide fuels cells sealed with fired product of the sealing glass composition according to one of 5-8 above.

### Effects of Invention

The present invention described above enables production of a sealing glass composition that is substantially free of alkali metals and crystallizes when subjected to firing and thus gives a high thermal expansion, high-strength crystallized glass having a thermal expansion coefficient of not less than 130×10⁻⁷/° C. Therefore, it can be used as a sealant for such positions where sealing is necessary between a metal and a metal, a metal and a ceramic, or a ceramic and a ceramic, which are used at high temperatures (e.g., sealing positions of solid oxide fuel cells or exhaust gas sensors). As it will not lose its electrical insulating property even after exposure to high temperature conditions of 700-1000° C. for an extended length of time, nor will its viscosity decline at such high temperatures, its application to sealing positions as a sealant can provide fortified durability of its electrical insulating property and sealing property.

### DESCRIPTION OF EMBODIMENTS

After its powder, or a paste made from the powder, is filled into such positions to be sealed of SOFC constructed of metals (e.g., stainless steel (SUS)) and ceramics, and then fired, the sealing glass composition according to the present invention produces crystallized glass adhering both to the metals and the ceramics, thereby sealing between them. Such firing may be performed at 850-1050° C. (e.g., 1000° C.).

The sealing glass composition of the present invention is produced as bulk glass (not crystallized) by blending raw materials such as oxides, hydroxides, carbonates and the like, melting them (e.g., at 1300-1500° C.), and then cooling the melt, which may be pulverized to make it in the form of powder.

In the present invention, the phrase “substantially not containing alkali metals” means that any use of raw material is prevented that includes alkali metal oxides as a main component, and does not intended to exclude using raw materials containing a minimum amount of alkali metals coming from contaminants in raw materials for making the glass and inorganic fillers. The alkali metal content of the sealing glass composition of the present invention is preferably not more than 100 ppm, more preferably not more than 30 ppm, and particularly preferably not more than 10 ppm.

From the viewpoint of protection of the environment, the sealing glass composition of the present invention is preferably lead-free (less than 1000 ppm lead), and thus addition of a lead-containing material should be avoided.

The ranges of the content of the respective components of the sealing glass according to the present invention are as follows:

SiO₂, a component as glass network former, is an essential component for improving the stability of the glass during production of bulk glass, as well as for producing CaO—MgO—SiO₂-based high thermal extension crystals (diopside, and the like). Glass compositions that precipitate CaO—MgO—SiO₂-based crystals (diopside, and the like) and MgO—SiO₂-based crystals (enstatite, forsterite, and the like) are less likely to undergo transformation of their crystal phase at firing temperatures, and they thus tend to stabilize the strength after crystallization.

On the other hand, if crystals occur in bulk glass, a powder formed by pulverization of it will start to crystallize early during its firing for sealing so that the flowability of the composition will decrease at an early stages after the start of firing and thus hinder the flow, likely causing the problem of space being left behind between itself and the object for sealing, which is undesirable. In the combination of components of the present invention, the content of SiO₂ less than 12 mass % is undesirable, for it would cause decreased stability during production of bulk glass, and also because it would fail to sufficiently produce CaO—MgO—SiO₂-based high thermal expansion crystals (diopside, and the like) by firing after its pulverization. In addition, it is also undesirable that the content of SiO₂ exceeds 25 mass %, for this would make crystal formation difficult during firing.

Therefore, the content of SiO₂ is preferably 12-25 mass %, more preferably 12-20 mass %, and still more preferably 13-18 mass %.

B₂O₃, a component as glass network former, is an essential component for improving the stability of the glass during production of bulk glass and for lowering the crystallization temperature of the glass in the form of powder during firing, and to produce MgO—B₂O₃-based high thermal expansion crystals. In the combination of components of the present invention, the content of B₂O₃ of less than 10 mass % is undesirable for it would cause decreased stability during production of bulk glass, and for it would also fail to sufficiently produce MgO—B₂O₃-based crystals. At the same time, it is undesirable that the content of B₂O₃ of not less than 20 mass %, for it would increase the proportion of remaining glass phase left uncrystallized after firing, thereby leading to lowered thermal expansion coefficient.

Therefore, the content of B₂O₃ is preferably 10-20 mass % (but not including 20 mass %), more preferably 13-19 mass %.

CaO is a component which increases the degree of crystallization after firing, and an component which is essential for producing a CaO—MgO—SiO₂-based high thermal expansion crystals. In the combination of components of the present invention, the content of CaO of less than 18 mass % is undesirable, for it would result in insufficient degree of crystallization after firing in the form of powder, leaving a substantial proportion of glass phase relative to the crystal phase and thereby lowering heat resistance. In addition, the content of CaO exceeding 30 mass % is undesirable because it would lower the stability of bulk glass during production. In the present invention, CaO—MgO—SiO₂-based high thermal expansion crystals are mainly precipitated through adjusting the proportion of each of components, CaO, SiO₂, MgO and BaO, in a specified respective region. Thus, the content of CaO is preferably 18-30 mass %, and more preferably 20-29 mass %.

MgO is an essential component for producing MgO—B₂O₃-based, CaO—MgO—SiO₂-based, BaO—MgO—SiO₂-based, and MgO—SiO₂-based high thermal expansion crystals. In the combination of components of the present invention, the content of MgO of less than 15 mass % is undesirable, for it would result in insufficient degree of crystallization after firing in the form of powder, leaving behind a substantial proportion of glass phase relative to the crystal phase. And, too low a content of MgO would cause to raise the relative content of CaO and thus tend to produce CaO—SiO₂-based low thermal expansion crystals. At the same time, the content of MgO exceeding 30 mass % is undesirable, for it would lower the stability of the bulk glass during production and decrease the flowability of the composition during firing in the form of powder, thus hindering the flow.

Thus, the content of MgO is preferably 15-30 mass %, and more preferably 18-25 mass %.

BaO is an essential component for production of BaO—MgO—SiO₂-based, and BaO—SiO₂-based high thermal expansion crystals. In the combination of components of the present invention, if the content of BaO is less than 10.5 mass % an insufficient expansion coefficient might result after crystallization. Further, if the content of BaO exceeds 27 mass %, although glass will be obtained, its crystallization temperature might be lowered, posing a cause of cracks.

Therefore, the content of BaO is preferably 10.5-27 mass %, more preferably 10.5-27 mass %, and still more preferably 13-23 mass %.

Furthermore, in the combination of components of the present invention, it is also possible to adjust the degree of crystallization and the thermal expansion coefficient by partly replacing CaO, MgO, BaO with SrO, ZnO. However, the total content of SrO and ZnO, when employed, is preferably not more than 3 mass % for if their total content exceeds 3 mass %, either glass might fail to form, or too low a crystallization temperature might result.

ZrO₂ and TiO₂ are components which promote precipitation of crystals and improve weather resistance of the glass. Either one or both of them may be contained. However, the total content of ZrO₂ and TiO₂, when contained, is preferably not more than 3 mass %, for if their total content exceeds 3 mass %, either poor flowability might result during firing in the form of powder, or some of them might remain undissolved in the melt.

Al₂O₃, whose inclusion is optional, is a component that, in the combination of components of the present invention, can be contained in order to improve glass forming ability, as well as to adjust crystallization temperature. In the case where it is contained, the content of Al₂O₃ preferably does not exceed 1 mass %. This is because if it exceeds 1 mass %, it could prevent precipitation of high thermal expansion crystals.

Apart from the above components, either or both of La₂O₃ and CeO₂ may be contained, which are components serving to maintain strength of adhesion to metals. It is undesirable, however, that their total content exceeds 3 mass %, for it then will increase the proportion of glass phase remaining after firing in the form of powder. Thus, in the case where La₂O₃ and CeO₂ are contained, it is preferable that their total content does not exceed 3 mass %. Further, in place of, or in addition to, La₂O₃ and/or CeO₂, Yb₂O₃ and/or Y₂O3 may be contained. It, however, is preferable that the content of La₂O₃, CeO₂, Yb₂O₃, and Y₂O₃ does not exceed 3 mass % in total for the same reason as mentioned above.

The glass composition of the present invention is used in the form of powder, or further as a paste made from the powder, by applying it to the surface of metals, or a metal and a ceramic, and firing it into crystallized glass to seal them. As metals and ceramics are high thermal expansion materials, the crystallized grass produced has a thermal expansion coefficient of preferably not less than 130×10⁻⁷/° C., more preferably than135×10⁻⁷/° C. Further, though there is no specific upper limit, a maximum thermal expansion coefficient as high as 145×10⁻⁷/° C. is sufficient and there is no need to exceed this.

As the powder of the glass composition of the present invention is required to once shrink and then soften and flow wetting the surfaces of metals or ceramics as it is fired, it must exhibit high flowability during firing. For this purpose, it is preferable that its particle size be adjusted using conditions for dry pulverization.

In this regard, fine powder consisting of particles of too small particle sizes is not preferable, for it will start crystallizing too early, which then will reduce the composition's flowability during firing for sealing and thus hinder its flow, thereby requiring increased rounds of application and firing of the sealant and leading to increased costs of production. At the same time, coarse powder consisting of particles of too large sizes will cause problems that the particles of the powder settle and separate when the powder is made into a paste or while it is applied and dried, and also that uneven and insufficient crystallization will likely take place, resulting in reduced strength. The particles size can be adjusted by removing such fine or coarse powders through a process of sieving or the like. The mean particle size is preferably not smaller than 2 μm, more preferably not small than 4 μm, yet preferably not greater than 25 μm, and more preferably not greater than 20 μm. In addition, the maximum particle size is preferably not greater than 150 μm, and more preferably not greater than 100 μm.

Thus, adjustment may be made, for example, so as to attain the mean particle size of 25 μm along with the maximum particle size of not more than 150 μm; the mean particle size of 15 μm along with the maximum particle size of 100 μm; the mean particle size of 5 μm along with the maximum particle size of not more than 100 μm; or the mean particle size of 3 μm along with the maximum particle size of 75 μm, and so on.

Besides, in the present specification, the term “mean particle size” indicates the value obtained as D50 by particle size measurement using a laser diffraction particle size distribution analyzer operated in the volume distribution mode.

Furthermore, for the purpose of precisely adjusting the particle size, enhancing crystallization of the glass and improving its strength, ceramic filler may be added to the glass powder in such an amount as not lowering flowability of the resulting composition during firing. In such a case, it is added in an amount of preferably not more than 6 mass % relative to the glass powder.

As examples of fillers, there may be named barium titanate, alumina, zirconia, preferably partially-stabilized zirconia, magnesia, forsterite, steatite, wollastonite, and the like. The mean particle size of fillers is preferably not greater than 20 μm, more preferably not greater than 5 μm, and still more preferably not greater than 3 μm, and the maximum particle size is preferably not greater than 100 μm, more preferably not greater than 45 μm, and still more preferably not greater than 22 μm.

The sealing glass composition of the present invention may be used either in the form of powder or as a mixture of this and ceramic powder, as well as in the form of a paste, for example.

For using it in the form of a paste, the sealing glass composition of the present invention may be mixed with at least one of solvents and organic binders to prepare a paste. For example, a paste can be prepared by mixing the glass composition of the present invention in the form of powder with a solvent and an organic binder. When preparing a paste, the mean particle size of the sealing glass composition in the form of powder is preferably 2-25 μm usually, and more preferably 5-15 μm, though it is not particularly restricted.

There is no particular restriction as to what is employed as an organic binder, which can be chosen as desired from conventional binders in accordance with the particular application of the sealing glass composition. For example, but without limitation, cellulose resins such as ethylcellulose are named.

The solvents mentioned above may be chosen in accordance with the type of the binder and the like employed. For example, but without limitation, alcohols such as ethanol, isopropanol, and the like, and other organic solvents such as terpineol (α-terpineol, or a mixture of this with β-terpineol and γ-terpineol, where α-terpineol is the main component) are named. A solvent may either be used alone, or two or more solvents may be used in combination.

Other conventional additives may also be added as desired in preparing a paste, such as plasticizers, thickeners, sensitizers, surfactants, dispersants, and the like.

An object can be sealed with the sealing glass composition of the present invention by applying it on the surface of the object, by printing or through a dispenser, and firing it at 850-1050° C. It is also possible to dry press molding the sealing glass composition including a molding aid and calcine the molded composition at a temperature close to the softening point of the glass, and then to apply the calcined composition, in combination with the aforementioned paste, to the surface of an object and fire them. In the latter case, polyvinylalcohol may be employed as a non-limiting example of molding aids.

### EXAMPLES

Though the present invention will be described in further detail below referring to typical examples, it is not intended that the present invention be limited by those examples.

### [Production of Bulk Glass and Glass Powder]

### Examples 1-44 and Comparative Example 1

Raw materials were weighed and mixed to give the compositions shown in Tables 1-5. Each of those blends of raw materials was put in a platinum crucible and melted at 1300-1500° C. for two hours, and a bulk glass was obtained as glass flakes. The glass flakes were put in a pot mill and subjected to dry grinding until their mean particle size reached 5-10 μm. Coarse particles then were removed with a sieve having the pore size of 106 μm to provide a glass powder of each of Examples 1-44 and Comparative Example 1.

### [Test Methods]

The glass powders of Examples 1-44 and Comparative Example 1 were measured for their glass transition temperature, softening point, peak crystallization temperature, and mean particle size, as well as flow diameter and thermal expansion coefficient of their pressed powder compact after firing.

(1) Measurement of Glass Transition Temperature and Peak Crystallization Temperature (Tp)

A platinum cell was filled with about 40 mg of glass powder, and its glass transition temperature (Tg), softening point (Ts), and peak crystallization temperature (Tp) were measured while raising the temperature at a rate of 20° C/min starting from room temperature, on a DTA analyzer (Thermo Plus TG8120, manufactured by Rigaku Corporation). In the case where two crystallization peaks were observed, the first of them was designated Tp1, and the second Tp2.

(2) Measurement of Mean Particle Size (D50) of the Glass Powder

Using a laser scattering particle-size distribution analyzer, operated in the volume distribution mode, D50 values (μm) were determined.

(3) Flow Diameter of Pressed Powder Compact

Each powder obtained was placed in a 20-mm mold and subjected to press molding for 10 sec at 3 MPa, and then fired at 900° C. The diameter of thus obtained fired body was measured and designated flow diameter. In the same manner, a mixture powder consisting of the glass powder of Example 22 and a filler (barium titanate)(5 mass %) was fired, and the flow diameter of the fire body was measured, as shown in Table 6.

(4) Thermal Expansion Coefficient

Each of the fired bodies obtained in (3) above was cut out in the size of 5×5×15 mm to prepare a test piece. For each test piece, the thermal expansion coefficients (α) were determined based on respective two points, 50° C. and 550° C., 50° C. and 700° C., and 50° C. and 800° C., on the thermal expansion curve that was produced by raising its temperature at a rate of 10° C./min starting from room temperature.

TABLE 1

| Composition | Example | Example | Example | Example | Example | Example | Example | Example | Example | Example |
|---|---|---|---|---|---|---|---|---|---|---|
| (mass %) | 1 | 2 | 3 | 4 | 5 | 6 | 7 | 8 | 9 | 10 |
| SiO₂ | 12.5 | 13.0 | 13.3 | 14.0 | 14.0 | 18.0 | 18.0 | 18.5 | 20.0 | 24.0 |
| B₂O₃ | 18.4 | 17.9 | 18.2 | 13.0 | 13.0 | 19.0 | 19.0 | 19.5 | 10.0 | 10.0 |
| CaO | 26.2 | 26.2 | 20.1 | 18.0 | 30.0 | 18.0 | 18.0 | 29.8 | 22.0 | 22.0 |
| MgO | 16.7 | 16.7 | 21.7 | 30.0 | 18.0 | 30.0 | 20.0 | 21.7 | 22.0 | 22.0 |
| BaO | 26.2 | 26.2 | 26.7 | 25.0 | 25.0 | 15.0 | 25.0 | 10.5 | 26.0 | 22.0 |
| SrO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 0.0 | 0.0 |
| CeO₂ | 0.0 | 0.0 | 0.0 | 0.0 | 0.0 | 0.0 | 0.0 | 0.0 | 0.0 | 0.0 |
| | 100.0 | 100.0 | 100.0 | 100.0 | 100.0 | 100.0 | 100.0 | 100.0 | 100.0 | 100.0 |
| Tg (° C.) | 602 | 593 | 596 | 608 | 610 | 619 | 604 | 621 | 634 | 637 |
| Ts (° C.) | 646 | 679 | 681 | 688 | 683 | 692 | 682 | 672 | 685 | 727 |
| Tp1 (° C.) | 780 | 768 | 773 | 807 | 758 | 798 | 888 | 967 | 800 | 857 |
| Tp2 (° C.) | 876 | — | — | — | — | — | — | — | 866 | — |
| D50 | 13.7 | 15.3 | 16.2 | 7.9 | 14.7 | 10.2 | 12.3 | 12.5 | 16.2 | 13.4 |
| α(50-550) | 129 | 131 | 131 | 129 | 126 | 122 | 121 | 118 | 129 | 122 |
| α(50-700) | 138 | 136 | 135 | 136 | 132 | 133 | 127 | 126 | 137 | 132 |
| α(50-800) | 142 | 138 | 138 | 141 | 135 | 135 | 133 | 130 | 141 | 131 |
| Flow diameter | 17.8 | 17.1 | 19.1 | 17.0 | 18.0 | 17.1 | 19.5 | 20.5 | 17.2 | 17.1 |
| (900° C.) | | | | | | | | | | |

TABLE 2

| Composition | Example | Example | Example | Example | Example | Example | Example | Example | Example | Example |
|---|---|---|---|---|---|---|---|---|---|---|
| (mass %) | 11 | 12 | 13 | 14 | 15 | 16 | 17 | 18 | 19 | 20 |
| SiO₂ | 14.3 | 14.4 | 17.1 | 18.0 | 18.0 | 13.6 | 13.8 | 13.9 | 14.9 | 16.1 |
| B₂O₃ | 19.5 | 19.7 | 19.8 | 10.0 | 19.0 | 18.7 | 18.9 | 13.4 | 19.0 | 18.8 |
| CaO | 28.6 | 26.5 | 22.1 | 24.0 | 18.0 | 27.4 | 23.2 | 28.0 | 22.4 | 23.0 |
| MgO | 21.7 | 23.5 | 19.1 | 24.0 | 22.5 | 19.1 | 22.6 | 22.9 | 21.6 | 20.8 |
| BaO | 15.9 | 16.0 | 21.8 | 24.0 | 22.5 | 21.2 | 21.5 | 21.8 | 22.1 | 21.3 |
| SrO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 0.0 | 0.0 |
| CeO₂ | 0.0 | 0.0 | 0.0 | 0.0 | 0.0 | 0.0 | 0.0 | 0.0 | 0.0 | 0.0 |
| | 100.0 | 100.0 | 100.0 | 100.0 | 100.0 | 100.0 | 100.0 | 100.0 | 100.0 | 100.0 |
| Tg (° C.) | 609 | 610 | 600 | 628 | 609 | 603 | 606 | 592 | 606 | 604 |
| Ts (° C.) | 690 | 697 | 680 | 699 | 690 | 688 | 689 | 675 | 688 | 689 |
| Tp1 (° C.) | 765 | 868 | 870 | 758 | 890 | 813 | 905 | 769 | 779 | 903 |
| Tp2 (° C.) | 859 | 922 | 920 | — | — | — | — | 827 | 897 | — |
| D50 | 17.6 | 19.3 | 14.8 | 8.1 | 15.3 | 18.1 | 19.6 | 15.0 | 15.7 | 16.7 |
| α(50-550) | 127 | 126 | 126 | 129 | 124 | 130 | 129 | 128 | 130 | 121 |
| α(50-700) | 133 | 129 | 131 | 131 | 129 | 135 | 136 | 136 | 133 | 127 |
| α(50-800) | 136 | 133 | 135 | 133 | 134 | 141 | 140 | 142 | 137 | 133 |
| Flow diameter | 18.5 | 19.2 | 19.3 | 17.4 | 19.3 | 18.7 | 19.2 | 17.3 | 19.3 | 19.3 |
| (900° C.) | | | | | | | | | | |

TABLE 3

| Composition | Example | Example | Example | Example | Example | Example | Example | Example | Example | Example |
|---|---|---|---|---|---|---|---|---|---|---|
| (mass %) | 21 | 22 | 23 | 24 | 25 | 26 | 27 | 28 | 29 | 30 |
| SiO₂ | 16.1 | 16.2 | 16.3 | 18.0 | 18.0 | 18.0 | 18.0 | 18.0 | 16.2 | 18.0 |
| B₂O₃ | 15.9 | 18.9 | 16.2 | 19.0 | 19.0 | 15.0 | 15.0 | 19.0 | 18.9 | 19.0 |
| CaO | 27.5 | 20.9 | 23.3 | 21.0 | 22.5 | 21.0 | 25.0 | 18.0 | 20.9 | 20.5 |
| MgO | 19.2 | 22.6 | 22.7 | 21.0 | 18.0 | 25.0 | 21.0 | 21.0 | 19.6 | 21.0 |
| BaO | 21.3 | 21.5 | 21.6 | 21.0 | 22.5 | 21.0 | 21.0 | 21.0 | 23.4 | 21.0 |
| SrO | 0.0 | 0.0 | 0.0 | 0.0 | 0.0 | 0.0 | 0.0 | 3.0 | 0.0 | 0.0 |
| ZnO | 0.0 | 0.0 | 0.0 | 0.0 | 0.0 | 0.0 | 0.0 | 0.0 | 1.0 | 0.0 |
| ZrO₂ | 0.0 | 0.0 | 0.0 | 0.0 | 0.0 | 0.0 | 0.0 | 0.0 | 0.0 | 0.5 |
| TiO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 0.0 | 0.0 |
| CeO₂ | 0.0 | 0.0 | 0.0 | 0.0 | 0.0 | 0.0 | 0.0 | 0.0 | 0.0 | 0.0 |
| | 100.0 | 100.0 | 100.0 | 100.0 | 100.0 | 100.0 | 100.0 | 100.0 | 100.0 | 100.0 |
| Tg (° C.) | 611 | 609 | 614 | 602 | 609 | 615 | 620 | 603 | 604 | 607 |
| Ts (° C.) | 693 | 691 | 700 | 680 | 685 | 700 | 709 | 684 | 654 | 691 |
| Tp1 (° C.) | 775 | 851 | 845 | 868 | 884 | 838 | 804 | 915 | 905 | 926 |
| Tp2 (° C.) | 907 | — | — | — | 927 | 868 | — | — | — | — |
| D50 | 13.2 | 15.1 | 17.5 | 12.3 | 13.9 | 12.0 | 22.9 | 14.6 | 11.5 | 16.8 |
| α(50-550) | 121 | 129 | 130 | 127 | 127 | 118 | 126 | 119 | 117 | 124 |
| α(50-700) | 132 | 135 | 132 | 135 | 135 | 129 | 131 | 126 | 123 | 132 |
| α(50-800) | 133 | 139 | 136 | 139 | 139 | 130 | 134 | 131 | 130 | 135 |
| Flow diameter | 16.8 | 19.3 | 18.9 | 18.6 | 19.5 | 17.8 | 17.9 | 19.5 | 21.5 | 19.4 |
| (900° C.) | | | | | | | | | | |

TABLE 4

| Composition | Example | Example | Example | Example | Example | Example | Example | Example | Example |
|---|---|---|---|---|---|---|---|---|---|
| (mass %) | 31 | 32 | 33 | 34 | 35 | 36 | 37 | 38 | 39 |
| SiO₂ | 18.0 | 13.4 | 13.6 | 13.7 | 14.0 | 14.2 | 12.5 | 13.6 | 13.9 |
| B₂O₃ | 19.0 | 18.4 | 18.6 | 18.8 | 19.2 | 19.4 | 18.4 | 18.7 | 13.4 |
| CaO | 20.5 | 26.9 | 27.2 | 23.1 | 26.0 | 26.4 | 24.2 | 27.4 | 28.0 |
| MgO | 21.0 | 17.7 | 19.0 | 22.5 | 20.9 | 21.1 | 16.7 | 17.1 | 19.9 |
| BaO | 21.0 | 23.1 | 21.1 | 21.4 | 14.2 | 14.4 | 26.2 | 21.2 | 21.8 |
| SrO | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 | 0.0 | 0.0 |
| TiO₂ | 0.5 | 0.0 | 0.0 | 0.0 | 2.6 | 2.6 | 0.0 | 0.0 | 0.0 |
| Al₂O₃ | 0.0 | 0.5 | 0.5 | 0.5 | 0.5 | 0.5 | 0.0 | 0.0 | 0.0 |
| La₂O₃ | 0.0 | 0.0 | 0.0 | 0.0 | 2.6 | 0.0 | 2.0 | 2.0 | 3.0 |
| CeO₂ | 0.0 | 0.0 | 0.0 | 0.0 | 0.0 | 1.4 | 0.0 | 0.0 | 0.0 |
| | 100.0 | 100.0 | 100.0 | 100.0 | 100.0 | 100.0 | 100.0 | 100.0 | 100.0 |
| Tg (° C.) | 604 | 601 | 607 | 609 | 619 | 621 | 601 | 608 | 616 |
| Ts (° C.) | 688 | 649 | 686 | 689 | 668 | 675 | 662 | 667 | 683 |
| Tp1 (° C.) | 926 | 815 | 787 | 779 | 948 | 950 | 819 | 828 | 760 |
| Tp2 (° C.) | — | — | — | 904 | — | — | 878 | 887 | — |
| D50 | 17.2 | 12.2 | 17.0 | 17.1 | 13.6 | 16.3 | 17.0 | 17.3 | 14.7 |
| α(50-550) | 124 | 129 | 124 | 128 | 114 | 112 | 126 | 116 | 122 |
| α(50-700) | 129 | 132 | 132 | 135 | 128 | 129 | 134 | 127 | 128 |
| α(50-800) | 138 | 136 | 136 | 138 | 130 | 132 | 137 | 130 | 131 |
| Flow diameter | 19.4 | 18.9 | 18.7 | 19.1 | 19.8 | 19.5 | 19.0 | 18.9 | 17.8 |
| (900° C.) | | | | | | | | | |

TABLE 5

| Composition | Example | Example | Example | Example | Example | Composition | Comparative |
|---|---|---|---|---|---|---|---|
| (mass %) | 40 | 41 | 42 | 43 | 44 | (mass %) | Example 1 |
| SiO₂ | 18.0 | 18.0 | 18.0 | 13.8 | 13.8 | SiO₂ | 20.0 |
| B₂O₃ | 19.0 | 19.0 | 19.0 | 18.9 | 18.9 | B₂O₃ | 15.0 |
| CaO | 19.5 | 19.5 | 22.5 | 20.2 | 23.2 | CaO | 5.0 |
| MgO | 18.0 | 18.0 | 15.0 | 22.6 | 19.6 | MgO | 25.0 |
| BaO | 22.5 | 22.5 | 22.5 | 21.5 | 21.5 | BaO | 25.0 |
| SrO | 0.0 | 0.0 | 0.0 | 0.0 | 0.0 | SrO | 0.0 |
| ZnO | 0.0 | 0.0 | 0.0 | 0.0 | 0.0 | ZnO | 7.0 |
| ZrO₂ | 0.0 | 0.0 | 0.0 | 0.0 | 0.0 | ZrO₂ | 0.0 |
| TiO₂ | 0.0 | 0.0 | 0.0 | 0.0 | 0.0 | TiO₂ | 0.0 |
| Al₂O₃ | 0.0 | 0.0 | 0.0 | 0.0 | 0.0 | Al₂O₃ | 3.0 |
| La₂O₃ | 2.0 | 2.0 | 2.0 | 2.0 | 2.0 | La₂O₃ | 0.0 |
| CeO₂ | 0.0 | 0.0 | 0.0 | 0.0 | 0.0 | SnO₂ | 1.0 |
| Yb₂O₃ | 1.0 | 0.0 | 0.0 | 1.0 | 0.0 | | |
| Y₂O₃ | 0.0 | 1.0 | 1.0 | 0.0 | 1.0 | | |
| | 100.0 | 100.0 | 100.0 | 100.0 | 100.0 | | 101.0 |
| Tg (° C.) | 609 | 610 | 605 | 613 | 613 | Tg (°c) | 627 |
| Ts (° C.) | 677 | 700 | 666 | 688 | 676 | Ts (° C.) | 708 |
| Tp1 (° C.) | 927 | 934 | 851 | 904 | 904 | Tp1 (° C.) | 835 |
| Tp2 (° C.) | — | — | — | — | — | Tp2 (° C.) | — |
| D50 | 22.1 | 14.8 | 19.0 | 13.0 | 18.9 | D50 | 12.3 |
| α(50-550) | 114 | 109 | 104 | 119 | 117 | α(50-550) | 117 |
| α(50-700) | 125 | 126 | 122 | 126 | 127 | α(50-700) | 125 |
| α(50-800) | 131 | 130 | 130 | 130 | 132 | α(50-800) | 129 |
| Flow diameter | 19.6 | 19.6 | 20.5 | 19.7 | 19.7 | Flow diameter | 18.4 |
| (900° C.) | | | | | | (900° C.) | |

TABLE 6

| | | |
|---|---|---|
| Glass:Filler (mass %) | 95 | 5 |

| | |
|---|---|
| Example glass | Example 22 |
| Filler | Barium titanate |
| α(50-550) | 125 |
| α(50-700) | 131 |
| α(50-800) | 134 |
| Flow diameter (900° C.) | 19.3 |

As shown in the above tables, the glass of Examples 1-44 exhibited excellent properties meeting the purpose of the present invention. In contrast, the glass of Comparative Example 1 resulted in a thermal expansion coefficient which was less than 130×10⁻⁷/° C. (50-800° C.) after firing. Besides, the mixture consisting of the glass of Example 22 and barium titanate (5 mass %) also showed an excellent properties meeting the purpose of the present invention.

### INDUSTRIAL APPLICABILITY

The glass composition of the present invention is an alkali metal-free sealant that can provide a seal between materials, such as a metal and a metal, a metal and a ceramic, or a ceramic and a ceramic, through its application to their surfaces and firing at 850-1050° C., and it is particularly useful, for it consistently provides a high thermal expansion crystallized glass suitable for use in an environment exposed to 700-1000° C., s such as in solid oxide fuel cells (SOFC), and the like.

1. A sealing glass composition substantially not containing alkali metal oxides, but containing
SiO₂ 12-25 mass %,
B₂O₃ 10-20 mass % (but, not including 20 mass %),
CaO 18-30 mass %,
MgO 15-30 mass %,
BaO 10.5-27 mass %,
wherein the glass composition, when fired in the form of glass powder at a temperature of 850-1050° C., produces a crystallized glass that exhibits a thermal expansion coefficient of at least 130×10⁻⁷/° C. in the range of 50-800° C.

2. The sealing glass composition according to claim 1 substantially not containing alkali metal oxides, but containing
SiO₂ 12-20 mass %,
B₂O₃ 13-19 mass %,
CaO 20-29 mass %,
MgO 18-25 mass %,
BaO 10.5-25 mass %,
wherein the glass composition, when fired in the form of glass powder at a temperature of 850-1050° C., produces a crystallized glass that exhibits a thermal expansion coefficient of at least 130×10⁻⁷/° C. in the range of 50-800° C.

3. The sealing glass composition according to claim 1 substantially not containing alkali metal oxides, but containing
SiO₂ 13-18 mass %,
B₂O₃ 13-19 mass %,
CaO 20-29 mass %,
MgO 18-25 mass %,
BaO 13-23 mass %,
wherein the glass composition, when fired in the form of glass powder at a temperature of 850-1050° C., produces a crystallized glass that exhibits a thermal expansion coefficient of at least 130×10⁻⁷/° C. in the range of 50-800° C.

4. The sealing glass composition according to claim 1, containing one or more species selected from the group consisting of La₂O₃, CeO₂, Yb₂O₃ and Y₂O₃, in a total amount of not more than 3 mass %.

5. The sealing glass composition according to claim 1 in the form of powder.

6. The sealing glass composition according to claim 5, wherein the mean particle size of the powder is 2-25 μm.

7. The sealing glass composition according to claim 5 containing a ceramic filler.

8. The sealing glass composition according to claim 5 containing a solvent and an organic binder, and in the form of paste.

9. Solid oxide fuels cells sealed with fired product of the sealing glass composition according to claim 5.
